(19) United States
(12) Patent Application Publication
(10) Pub. No.: US 2018/0291518 A1
(43) Pub. Date: Oct. 11, 2018

(54) MANUFACTURING METHOD OF A TOOL SURFACE MARK

(71) Applicant: CHIEH-WEN LIU, TAICHUNG CITY (TW)

(72) Inventor: CHIEH-WEN LIU, TAICHUNG CITY (TW)

(21) Appl. No.: 15/484,342

(22) Filed: Apr. 11, 2017

(51) Int. Cl. C25D 5/14; C25D 3/04; C25D 3/12; C25D 21/08; C25D 5/48; B41F 17/00; B25B 13/06; G09F 23/00

(52) U.S. Cl. CPC C25D 5/14; C25D 3/04; C25D 3/12; G09F 23/00; C25D 5/48; B41F 17/00; B25B 13/06; C25D 21/08

(57) ABSTRACT

A manufacturing method of a tool surface mark includes a first cleaning step, a first electroplating step, a second cleaning step, a drying step, a printing step, a cation removal step, and a second electroplating step. In the first electroplating step, the surface of the tool is electroplated, and a first protective layer is formed on the surface of the tool. In the cation removal step, the tool is placed into an electrolyte and then electrically connected to an anode, the anode is electrically energized, and metal cations on the surface of the tool and on the printing pattern are dissolved. In the second electroplating step, the surface of the tool is electroplate at potions without the printing pattern to form a second protective layer. The yield of the printing pattern increases and the printing pattern does not easy peel off.

### BACKGROUND OF THE INVENTION

### 1. Field of the Invention

The present invention relates to a manufacturing method of a surface mark, especially to a manufacturing method of a tool surface mark.

### 2. Description of Related Art

Metal hand tools such as sleeves, screwdrivers or wenches, in order to apply to bolts or nuts of different sizes, would be designed in different sizes. In addition, to prevent a user from getting confused with similar metal tools of different sizes, an outer surface of the metal hand tool is marked to ensure that the user will not be confused when retrieving the metal hand tool.

TW invention patent No. 1323689, entitled “Metal hand tool and manufacturing method thereof” mainly discloses printing directly on the surface of a finished product to form a printing layer on the surface of the product. An electroplated layer is formed on the area of the product other than the printing layer. However, in the above-mentioned conventional marking method, the electroplated layer is formed after the printing layer is formed, and the printing layer is easily spotted due to the electroplating layer. This may result in a low yield of printing patterns, and the surface of the hand tool easily peels off, causing the difficulty of recognizing the hand tool.

To overcome the shortcomings of the conventional metal hand tool and manufacturing method thereof, the present invention provides a manufacturing method of a tool surface mark to mitigate or obviate the aforementioned problems.

### SUMMARY OF THE INVENTION

The main objective of the present invention is to provide a manufacturing method of a tool surface mark that includes a first cleaning step, a first electroplating step, a second cleaning step, a drying step, a printing step, a cation removal step, and a second electroplating step. In the first electroplating step, the surface of the tool is electroplated to form a first protective layer on the surface of the tool. In the cation removal step, the tool is placed into an electrolyte and then electrically connected to an anode, the anode is electrically energized, and metal cations on the surface of the tool and on the printing pattern are dissolved. In the second electroplating step, the surface of the tool is electroplated at portions without the printing pattern thereon to form a second protective layer. The yield of the printing pattern increases and the printing pattern is not prone to peeling off.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a manufacturing method of a tool surface mark in accordance with the present invention;

FIG. 2 is a cross-sectional side view of a preferred embodiment of a hand tool made by the method in FIG. 1; and

FIG. 3 is a perspective view of the preferred embodiment of the hand tool in FIG. 2.

### DETAILED DESCRIPTION OF PREFERRED EMBODIMENT

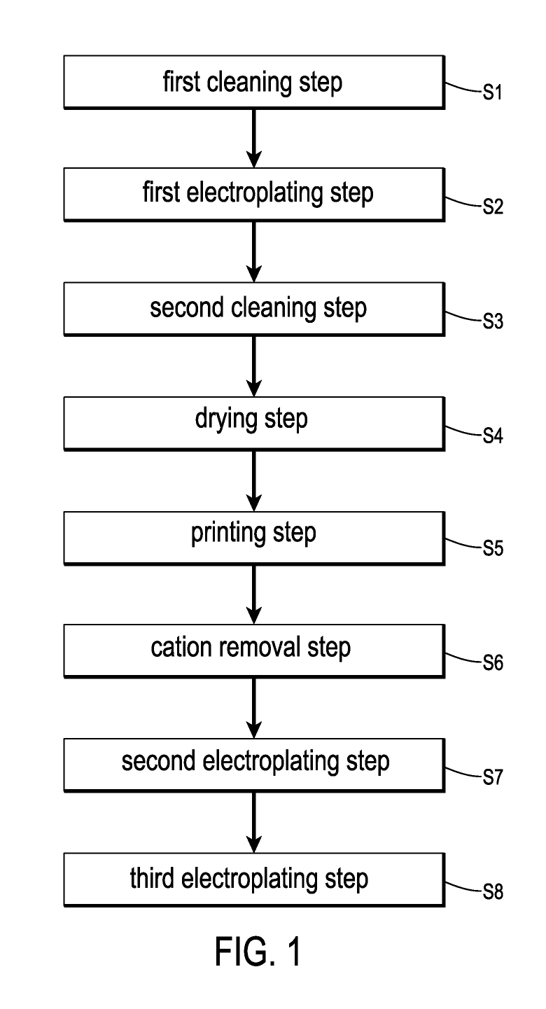

With reference to FIG. 1, a manufacturing method of a tool surface mark in accordance with the present invention comprises the following steps: a first cleaning step S1, a first electroplating step S2, a second cleaning step S3, a drying step S4, a printing step S5, a cation removal step S6, a second electroplating step S7, and a third electroplating step S8.

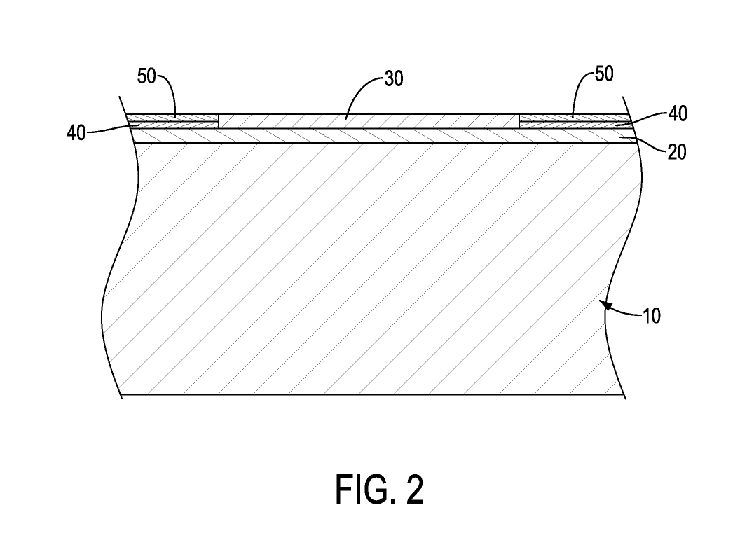

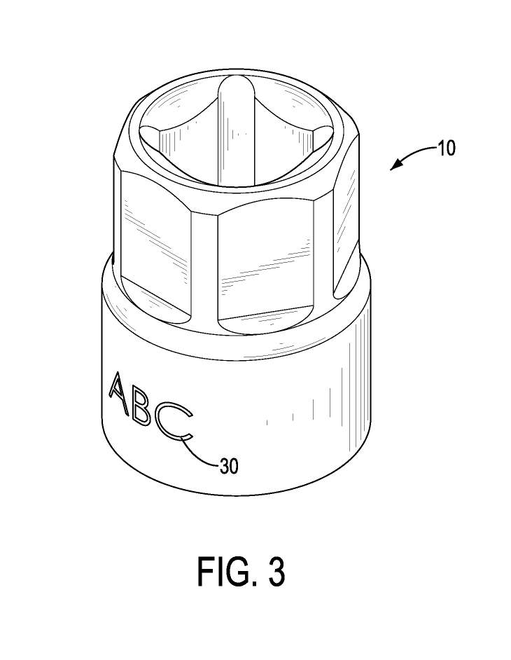

With reference to FIGS. 1 to 3, in the first cleaning step S1, a surface of a tool 10 is cleaned by clear water to remove impurities, such as dusts.

In the first electroplating step S2, the surface of the tool 10 is electroplated with nickel so that the surface of the tool 10 forms a first protective layer 20.

In the second cleaning step S3, the surface of the tool 10 is cleaned with distilled water to clean the plating solution on the surface of the tool 10, wherein the plating solution may be a sulfide.

In the drying step S4, the surface of the tool 10 is dried.

In the printing step S5, a printing pattern 30 is printed on the surface of the tool 10, and the printing pattern 30 may be a text or a figure.

In the cation removal step S6, the surface of the tool 10 is cleaned by removing cations. The cation removal comprises placing the tool 10 into an electrolyte, then electrically connecting the tool 10 to an anode, and electrically energizing the anode. Metal cations on the surface of the tool 10 and on the printing pattern 30 are dissolved. The cations are attracted by the anions in the electrolyte, and the metal cations on the surface of the tool 10 and on the printing pattern 30 are moved into the electrolyte, whereby the cations on the surface of the tool 10 and on the printing pattern 30 are removed.

In the second electroplating step S7, the surface of the tool 10 is electroplated with nickel at portions without the printing pattern 30 thereon so that a second protective layer 40 is formed on the surface of the tool 10 at the potions without the printing pattern 30, since the aforementioned cation removal step causes the tool 10 to have no residual cation on the printing pattern 30. The anions on the printing pattern 30 also leaves the surface of the printing pattern 30 due to the electroplating during the second electroplating step S7, so the surface of the printing pattern 30 is free of ions. Thus, no plating impurities are generated on the printing pattern 30, and the yield of the printing pattern 30 is increased and the printing pattern 30 does not easily peel off.

In the third electroplating step S8, a layer of chromium is electroplated on a surface of the second protective layer 40 so that a third protective layer 50 is formed on the surface of the second protective layer 40.

The method in accordance with the present invention mainly removes the cations on the surface of the tool 10 and the surface of the printing pattern 30 through the cation removal step so that the tool 10 has no residual cations on the printing pattern 30 after the second electroplating step S7. The printing pattern 30 does not have any ions, so no electroplated impurity is generated on the printing pattern 30, the yield of the printing pattern 30 is enhanced, and the printing pattern 30 does not easily peel off.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing method comprising:
a first cleaning step, wherein a surface of a tool is cleaned by clear water to remove impurities;
a first electroplating step, wherein the surface of the tool is electroplated and a first protective layer is formed on the surface of the tool;
a second cleaning step, wherein the surface of the tool is cleaned to remove sulfide from the surface of the tool;
a drying step, wherein the surface of the tool is dried;
a printing step, wherein a printing pattern is printed on the surface of the tool;
a cation removal step, wherein the tool is placed into an electrolyte and then electrically connected to an anode, the anode is electrically energized, metal cations on the surface of the tool and on the printing pattern are dissolved, the cations are attracted by anions in the electrolyte, and the metal cations on the surface of the tool and on the printing pattern are moved into the electrolyte, whereby the cations on the surface of the tool and the cations on a surface of the printing pattern are removed; and
a second electroplating step, wherein the surface of the tool is electroplated at potions without the printing pattern thereon to form a second protective layer on the surface of the tool at the portions witout the printing pattern.

2. The manufacturing method as claimed in claim 1 further comprising a third electroplating step after the second electroplating step to electroplate a third protective layer on a surface of the second protective layer.

3. The manufacturing method as claimed in claim 2, wherein in the first electroplating step, the surface of the tool is electroplated with a layer of nickel.

4. The manufacturing method as claimed in claim 3, wherein in the second electroplating step, the surface of the tool is electroplated with a layer of nickel.

5. The manufacturing method as claimed in claim 4, wherein in the third electroplating step, the surface of the tool is electroplated with a layer of chromium.

6. The manufacturing method as claimed in claim 1, wherein in the second cleaning step, the surface of the tool is cleaned with distilled water.

7. The manufacturing method as claimed in claim 2, wherein in the second cleaning step, the surface of the tool is cleaned with distilled water.

8. The manufacturing method as claimed in claim 3, wherein in the second cleaning step, the surface of the tool is cleaned with distilled water.

9. The manufacturing method as claimed in claim 4, wherein in the second cleaning step, the surface of the tool is cleaned with distilled water.

10. The manufacturing method as claimed in claim 5, wherein in the second cleaning step, the surface of the tool is cleaned with distilled water.
